(19) United States
(12) Patent Application Publication
(10) Pub. No.: US 2022/0281091 A1
(43) Pub. Date: Sep. 8, 2022

(54) SIDE HANDLE ASSEMBLY FOR POWER TOOL

(71) Applicant: MILWAUKEE ELECTRIC TOOL CORPORATION, Brookfield, WI (US)

(72) Inventors: Beth E. Cholst, Wauwatosa, WI (US); Troy C. Thorson, Cedarburg, WI (US)

(21) Appl. No.: 17/689,567

(22) Filed: Mar. 8, 2022

Related U.S. Application Data
(60) Provisional application No. 63/157,930, filed on Mar. 8, 2021.

(51) Int. Cl. B25D 17/04

(52) U.S. Cl. CPC B25D 17/043; B25D 2217/0073

(57) ABSTRACT

The present disclosure provides a side handle assembly for a power tool. The side handle assembly includes a clamp configured to secure the side handle assembly to the power tool, the clamp coaxially aligned with a working axis of the power tool, and a handle coupled to the clamp. The handle includes a base coupled to the clamp, a first grip portion coupled to the base, a second grip portion coupled to the base and movable relative to the first grip portion in a direction parallel to the working axis, and a damping element located between the first grip portion and the second grip portion to attenuate vibration from the power tool along the working axis.

### CROSS-REFERENCE TO RELATED APPLICATIONS

This application claims priority to U.S. Provisional Patent Application No. 63/157,930, filed on Mar. 8, 2021, the entire content of which is incorporated herein by reference.

### FIELD OF THE INVENTION

The present invention relates to power tools, and more particularly to side handle assemblies for use with power tools.

### BACKGROUND OF THE INVENTION

Power tools, such as rotary power tools (e.g., drill drivers, hammer drills, rotary hammers, etc.) are typically used with side handle assemblies to provide the operator of the tool with an additional location where the power tool can be grasped to exert leverage while the power tool is being used. Such side handle assemblies are typically clamped to a neck on the power tool along a working axis of the power tool.

### SUMMARY OF THE INVENTION

The present invention provides, in one aspect, a side handle assembly for a power tool. The side handle assembly includes a clamp configured to secure the side handle assembly to the power tool, the clamp coaxially aligned with a working axis of the power tool, and a handle coupled to the clamp. The handle includes a base coupled to the clamp, a first grip portion coupled to the base, a second grip portion coupled to the base and movable relative to the first grip portion in a direction parallel to the working axis, and a damping element located between the first grip portion and the second grip portion to attenuate vibration from the power tool along the working axis.

The present invention provides, in another aspect, a side handle assembly for a power tool. The side handle assembly includes a clamp configured to secure the side handle assembly to the power tool, the clamp coaxially aligned with a working axis of the power tool, and a handle coupled to the clamp. The handle includes a base coupled to the clamp, a first grip portion coupled to a first side of the base, and a second grip portion coupled to an opposite, second side of the base to clamp the base therebetween. The base includes a flexible portion to permit bending of the first and second grip portions relative to the clamp.

The present invention provides, in yet another embodiment, a rotary power tool including a housing, a motor disposed within the housing, a chuck configured to receive torque from the motor, and a removable side handle assembly. The side handle assembly includes a clamp configured to secure the side handle assembly to the housing and a handle coupled to the clamp. The handle includes a base coupled to the clamp, a first grip portion coupled to the base, a second grip portion coupled to the base and movable relative to the first grip portion, and a damping element disposed between the first grip portion and the second grip portion.

Other features and aspects of the invention will become apparent by consideration of the following detailed description and accompanying drawings.

### BRIEF DESCRIPTION OF THE DRAWINGS

FIG. 1 is a perspective view of a rotary hammer including a side handle assembly.

FIG. 2 is a perspective view of a side handle assembly in accordance with an embodiment of the invention for use with the rotary hammer of FIG. 1.

FIG. 3 is an exploded, front perspective view of a handle of the side handle assembly of FIG. 2.

FIG. 4 is a cross-sectional view of the side handle assembly along section line 4-4 in FIG. 2.

FIG. 5 is a cross-sectional view of the side handle assembly along section line 5-5 in FIG. 2.

FIG. 6 is a cross-sectional view of the side handle assembly along section line 6-6 in FIG. 2.

FIG. 7 is a perspective view of a side handle assembly in accordance with another embodiment of the invention for use with the rotary hammer of FIG. 1.

FIG. 8 is an exploded, front perspective view of a handle of the side handle assembly of FIG. 7.

FIG. 9 is an exploded, rear perspective view of the handle of the side handle assembly of FIG. 7.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

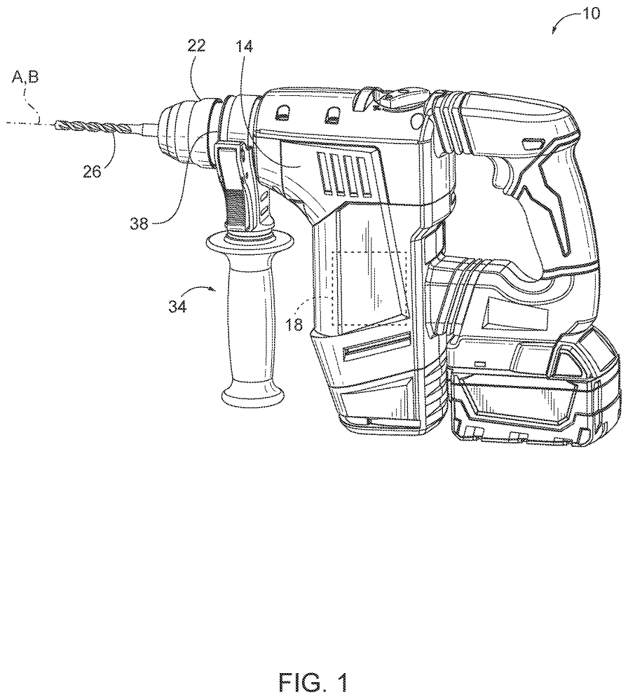

FIG. 1 illustrates a rotary power tool, such as a rotary hammer 10. The rotary hammer 10 includes a housing 14, a motor 18 disposed within the housing 14, and a spindle (not shown) that receives torque from the motor 18 to rotate the spindle about a rotational axis A. A tool bit 26 may be secured to the spindle (via a chuck 22) for co-rotation with the spindle (e.g., using a spline fit). The rotary hammer 10 also includes an impact mechanism that converts torque from the motor 18 to axial impacts imparted to the rear of the tool bit 26 along an impact axis B, which is coaxial with the rotational axis A. In the illustrated embodiment, the rotary hammer 10 includes a side handle assembly 34 to provide the operator of the rotary hammer 10 with an additional location (besides a rear handle) where the rotary hammer 10 can be grasped to exert leverage while the rotary hammer is being used. The side handle assembly 34 is mounted to a neck 38 of the rotary hammer 10, which is coaxial with the working axes A, B of the rotary hammer 10 (i.e., the rotational and impact axes), permitting the operator to grasp the rotary hammer 10 with two hands at two distinct locations (at the rear handle and the side handle assembly 34, proximate the front of the rotary hammer).

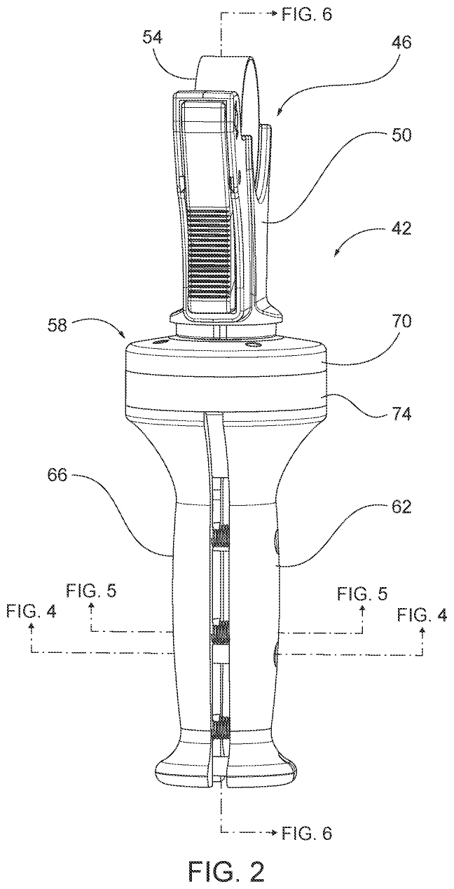

FIG. 2 illustrates a side handle assembly 42 for use with the rotary hammer 10 of FIG. 1. The side handle assembly 42 includes a clamp 46 that is mountable to the neck 38 of the rotary hammer 10. In the illustrated embodiment, the clamp 46 includes a clamp housing 50 and a flexible band 54 protruding from the clamp housing 50 in a circular arrangement. The flexible band 54 may be loosened to increase the inner diameter of the band 54 (to remove the clamp 46 from the neck 38) or tightened to decrease the inner diameter of the band 54 (to secure the clamp 46 to the neck 38).

With reference to FIGS. 2-6, the side handle assembly 42 includes a base 58, a first grip portion 62 located on a first side of the base 58, and a second grip portion 66 located on an opposite, second side of the base 58. In the illustrated embodiment, the base 58 includes, at one end, a hub 70 to which the clamp 46 is rotatably coupled and, at an opposite end, a flexible element 74 to facilitate bending or misalignment of the first and second grip portions 62, 66 relative to the hub 70 (and the connected clamp 46). In some embodiments of the side handle assembly 42, the flexible element 74 is made from an elastomeric material and the hub 70 is co-molded or otherwise permanently affixed to the flexible element 74 without requiring fasteners rigidly interconnecting the hub 70 with the grip portions 62, 66. In other embodiments of the side handle assembly 42, the flexible element 74 may be omitted from the base 58, requiring the grip portions 62, 66 to be coaxially aligned with the base 58 and the connected clamp 46 at all times.

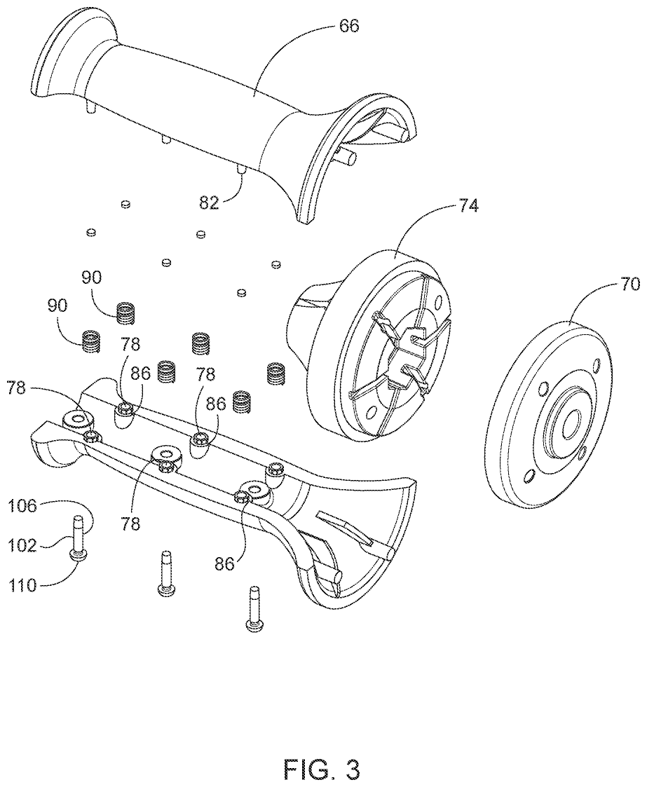

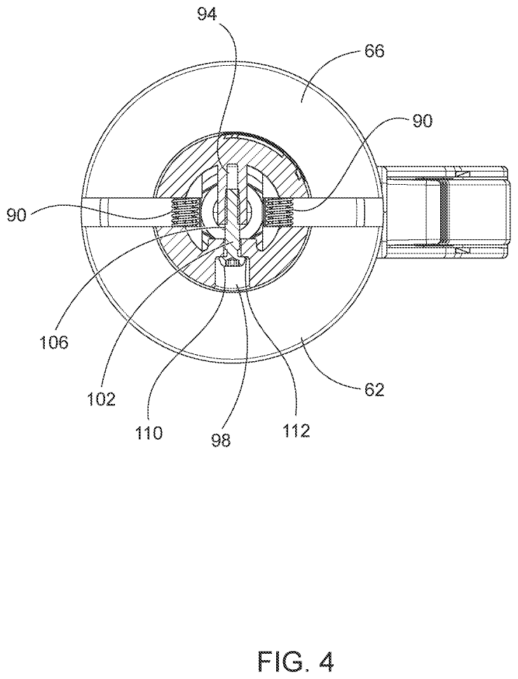

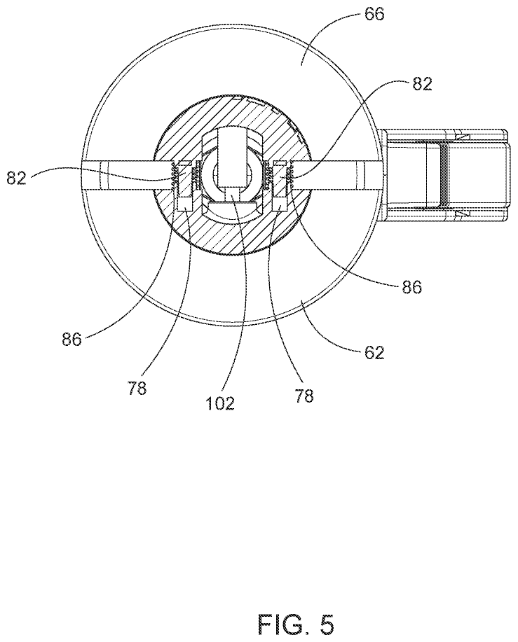

With reference to FIGS. 3 and 5, the first grip portion 62 includes a plurality of blind bores 78 and the second grip portion 66 includes a corresponding plurality of pins 82 that are slidably received within the bores 78. The first grip portion 62 also includes annular seats 86 surrounding the respective bores 78 around which respective damping elements (e.g., compression springs 90) are situated. As shown in FIGS. 4 and 5, the springs 90 surround the pins 82 and abut the second grip portion 66. With reference to FIG. 4, the second grip portion 66 includes a plurality of blind, threaded bores 94 and the first grip portion 62 includes a corresponding plurality of stepped apertures 98 through which fasteners 102 extend and are threaded into the threaded bores 94. As shown in FIG. 4, the fasteners 102 include an annular shoulder 106 adjacent the threaded section to limit the extent to which the fasteners 102 may be threaded into the threaded bores 94. The fasteners 102 also include heads 110 against which an internal, annular shoulder 112 of the stepped apertures 98 is abutted to limit the extent to which the first and second grip portions 62, 66 may move apart from one another, limiting the gap between the grip portions 62,66 to be less than the uncompressed lengths of the springs 90. Therefore, when the first and second grip portions 62, 66 are assembled onto the base 58, the springs 90 are preloaded and bias the grip portions 62, 66 apart to the maximum width of the gap. In some embodiments of the side handle assembly 42, the compression springs 90 have a low spring rate and are installed with a high pre-load.

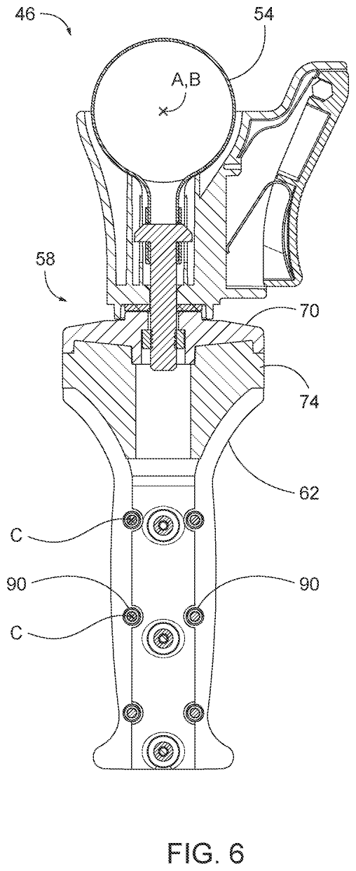

With reference to FIG. 6, the springs 90 are oriented along respective axes C that are parallel with the working axis A, B (i.e., the rotational axis and/or impact axis) of the rotary hammer 10. Therefore, during operation of the rotary hammer 10 with the side handle assembly 42 attached, the springs 90 attenuate vibration emitted from the rotary hammer 10 in a direction parallel with the working axis A, B of the rotary hammer 10. The grip portions 62, 66 are oriented so that an operator's hand will be perpendicular to the working axis A, B, thus allowing the operator to impart a force along the working axis A, B to help plunge the tool bit 26 into a workpiece and/or a moment about the working axis A, B to stabilize the rotary hammer 10 while the tool bit 26 is rotated. Each grip portion 62, 66 in the illustrated embodiment is substantially the same shape as the other, creating a symmetrical grip. The grip portions 62, 66 are also made from a rigid material, such as a hard plastic.

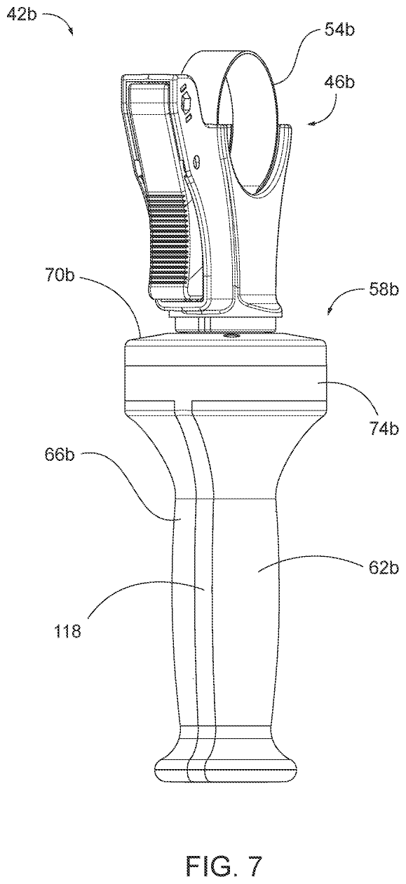

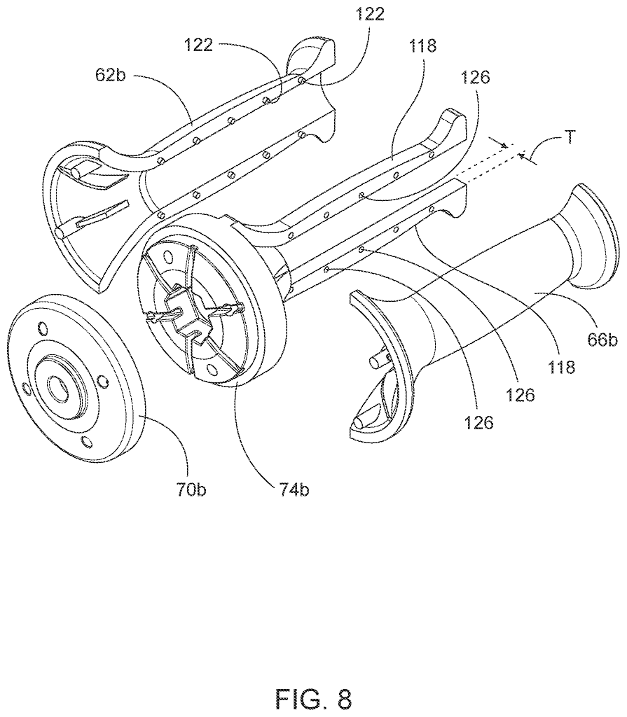

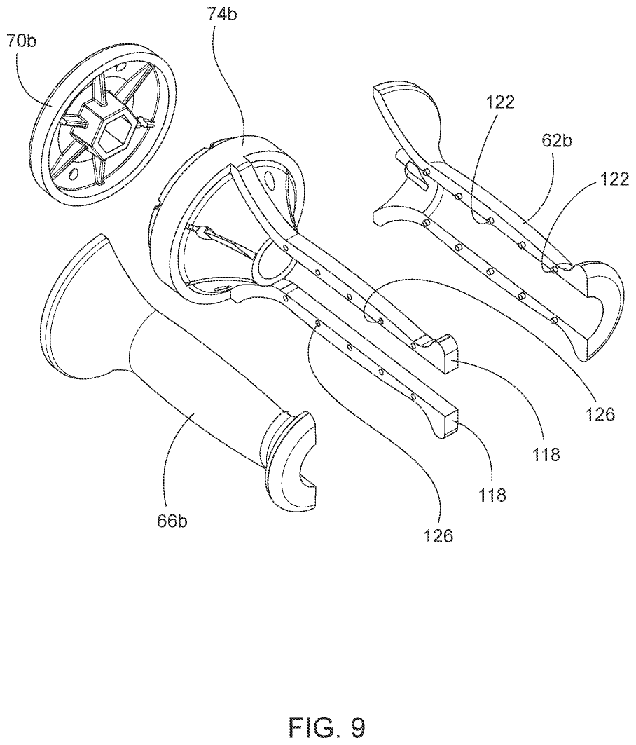

FIGS. 7-9 depict a side handle assembly 42b according to another embodiment of the invention. The side handle assembly 42b is similar to the side handle of the previous embodiment, with like parts having the same reference numeral plus the letter “b”, and the following differences explained below. Rather than using separate damping elements, such as the compression springs 90, between the first and second grip portions 62b, 66b, the side handle assembly 42b includes damping elements that are integrally formed with the flexible element 74b. In the illustrated embodiment, the damping elements are configured as ribs 118 extending from the rear of the flexible element 74b toward the ends of the respective grip portions 62b, 66b. And, the grip portions 62b, 66b include posts 122 embedded and/or received within corresponding blind apertures 126 in each of the ribs 118 to unitize the grip portions 62b, 66b with the ribs 118. Each of the ribs 118 has a thickness T extending in a direction parallel with the working axis A, B of the rotary hammer 10. As such, the ribs 118 are capable of attenuating vibration emitted from the rotary hammer 10 along the working axis A, B. In some embodiments, the ribs 118 may be separately formed from the flexible element 74b. And, in another embodiment with the flexible element 74b omitted, the ribs 118 may extend along the entire length of each of the grip portions 62b, 66b and terminate proximate the hub 70b.

Although the invention has been described in detail with reference to certain preferred embodiments, variations and modifications exist within the scope and spirit of one or more independent aspects of the invention as described.

Various features of the invention are set forth in the following claims.

What is claimed is:

1. A side handle assembly for a power tool, the side handle assembly comprising:
a clamp configured to secure the side handle assembly to the power tool, the clamp coaxially aligned with a working axis of the power tool; and
a handle coupled to the clamp, the handle including
a base coupled to the clamp,
a first grip portion coupled to the base,
a second grip portion coupled to the base and movable relative to the first grip portion in a direction parallel with the working axis, and
a damping element located between the first grip portion and the second grip portion to attenuate vibration from the power tool along the working axis.

2. The side handle assembly of claim 1, further comprising a plurality of pins interconnecting the first and second grip portions to limit relative movement between the first and second grip portions to translation in the direction parallel with the working axis.

3. The side handle assembly of claim 1, wherein the damping element is one of a plurality of compression springs positioned between the first and second grip portions.

4. The side handle assembly of claim 1, wherein the damping element is an elastomeric rib positioned between the first and second grip portions.

5. The side handle assembly of claim 1, wherein the base includes an elastomeric portion to permit bending of the first and second grip portions relative to the clamp.

6. The side handle assembly of claim 5, wherein the elastomeric portion permits rotation of the first and second grip portions relative to the clamp.

7. The side handle assembly of claim 1, wherein the clamp is a flexible band.

8. A side handle assembly for a power tool, the side handle assembly comprising:
a clamp configured to secure the side handle assembly to the power tool, the clamp coaxially aligned with a working axis of the power tool; and
a handle coupled to the clamp, the handle including
a base coupled to the clamp,
a first grip portion coupled to a first side of the base, and
a second grip portion coupled to an opposite, second side of the base to clamp the base therebetween,
wherein the base includes a flexible portion to permit bending of the first and second grip portions relative to the clamp.

9. The side handle assembly of claim 8, wherein the first grip portion is movably coupled to the second grip portion.

10. The side handle assembly of claim 9, further comprising a damping element disposed between the first grip portion and the second grip portion.

11. The side handle assembly of claim 10, wherein the damping element is one of a plurality of compression springs.

12. The side handle assembly of claim 11, wherein the first grip portion is movable a distance away from the second grip portion less than an uncompressed length of the compression springs.

13. The side handle assembly of claim 10, wherein the damping element is formed of an elastomeric material.

14. The side handle assembly of claim 13, wherein the elastomeric material is integrally formed with the flexible portion.

15. A rotary power tool comprising:
a housing;
a motor disposed within the housing;
a chuck configured to receive torque from the motor; and
a removable side handle assembly, the side handle assembly including
a clamp configured to secure the side handle assembly to the housing; and
a handle coupled to the clamp, the handle including
a base coupled to the clamp;
a first grip portion coupled to the base;
a second grip portion coupled to the base and movable relative to the first grip portion; and
a damping element disposed between the first grip portion and the second grip portion.

16. The rotary power tool of claim 15, further comprising an impact mechanism disposed between the motor and the chuck, wherein the impact mechanism is configured to convert torque from the motor to axial impacts upon a tool bit within the chuck.

17. The rotary power tool of claim 16, wherein a damping direction of the damping element is parallel to a direction of the axial impacts.

18. The rotary power tool of claim 15, further comprising a plurality of pins interconnecting the first and second grip portions to limit the relative movement between the first and second grip portions to translation.

19. The rotary power tool of claim 15, wherein the damping element is one of a plurality of compression springs positioned between the first and second grip portions.

20. The rotary power tool of claim 15, wherein the base includes an elastomeric portion to permit bending of the first and second grip portions relative to the clamp.
